(19) United States
(12) Patent Application Publication
(10) Pub. No.: US 2026/0253184 A1
(43) Pub. Date: Aug. 27, 2026

(54) IMAGE ARTIFACT CORRECTION

(71) Applicant: QUALCOMM Incorporated, San Diego, CA (US)

(72) Inventors: Haripriya K, Chennai (IN); Sandeep RAMISETTY, Hyderabad (IN); Pradeep VEERAMALLA, Hyderabad (IN)

(21) Appl. No.: 19/063,172

(22) Filed: Feb. 25, 2025

(51) Int. Cl. G06T 5/73; G06T 3/14; G06T 5/50

(52) U.S. Cl. CPC G06T 5/73; G06T 3/14; G06T 5/50; G06T 2207/20224

(57) ABSTRACT

Systems and techniques are provided for processing images. For example, a process can include obtaining a first image of a scene, obtaining a second image of the scene, the second image having a first blur level, and generating, based on the first image, a blurred first image. A second blur level of the blurred first image is configured to match the first blur level. The process can include aligning the blurred first image and the second image, determining a difference map between the blurred first image and the second image, and generating a corrected first image based on the first image and the difference map.

### FIELD

This present disclosure is generally related to image artifact correction.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

For image processing, automatic focusing (autofocus) can be used to focus an image. Existing solutions for autofocus include phase detection autofocus (PDAF) and contrast detection autofocus (CDAF). PDAF detects where light rays meet when entering the image sensor, ensuring that that objects are in focus. CDAF measures the intensity difference (contrast) between adjacent pixels of the image sensor and adjusts for the maximal contrast to correct the image focus.

### SUMMARY

Systems and techniques are described herein for image artifact correction.

According to at least one illustrative example, a method of image artifact correction is provided. The method includes: obtaining a first image of a scene; obtaining a second image of the scene, the second image having a first blur level; generating, based on the first image, a blurred first image, wherein a second blur level of the blurred first image is configured to match the first blur level; aligning the blurred first image and the second image; determining a difference map between the blurred first image and the second image; and generating a corrected first image based on the first image and the difference map.

In another example, an apparatus for image artifact correction is provided that includes a memory configured to store at least one frame and one or more processors (e.g., implemented in circuitry) coupled to the memory. The one or more processors are configured to and can: obtain a first image of a scene; obtain a second image of the scene, the second image having a first blur level; generate, based on the first image, a blurred first image, wherein a second blur level of the blurred first image is configured to match the first blur level; align the blurred first image and the second image; determine a difference map between the blurred first image and the second image; and generate a corrected first image based on the first image and the difference map.

In another example, a non-transitory computer-readable medium is provided that has stored thereon instructions that, when executed by one or more processors, cause the one or more processors to: obtain a first image of a scene; obtain a second image of the scene, the second image having a first blur level; generate, based on the first image, a blurred first image, wherein a second blur level of the blurred first image is configured to match the first blur level; align the blurred first image and the second image; determine a difference map between the blurred first image and the second image; and generate a corrected first image based on the first image and the difference map.

In accordance with another embodiment of the present disclosure, an apparatus for calibrating a phased array antenna is provided. The apparatus includes: means for obtaining a first image of a scene; means for obtaining a second image of the scene, the second image having a first blur level; means for generating, based on the first image, a blurred first image, wherein a second blur level of the blurred first image is configured to match the first blur level; means for aligning the blurred first image and the second image; means for determining a difference map between the blurred first image and the second image; and means for generating a corrected first image based on the first image and the difference map.

In some aspects, one or more of the apparatuses described herein is or is part of a camera, a mobile device (e.g., a mobile telephone or so-called “smart phone” or other mobile device), a wireless communication device, an extended reality device (e.g., a virtual reality (VR) device, an augmented reality (AR) device, or a mixed reality (MR) device), a wearable device, a personal computer, a laptop computer, a server computer, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing device, in accordance with some examples of the present disclosure;

FIG. 2 is a block diagram illustrating an architecture of an example extended reality (XR) system, in accordance with some examples of the present disclosure;

FIG. 3A illustrates an example plot of a waveform sampled with a sampling rate capable of reproducing the waveform, in accordance with some examples of the present disclosure;

FIG. 3B illustrates an example plot of undersampling the waveform of FIG. 3A, in accordance with some examples of the present disclosure;

FIG. 4A is a diagram illustrating an example of aliasing, in accordance with some examples of the present disclosure;

FIG. 4B is a diagram illustrating an example moiré pattern resulting from a repeating pattern, in accordance with some examples of the present disclosure;

FIG. 4C is a diagram illustrating aliasing of a signal waveform captured by a subset of eight pixels of an image sensor, in accordance with some examples of the present disclosure;

FIG. 4D is a diagram illustrating a Bayer color filter array, in accordance with some examples of the present disclosure;

FIG. 4E is a diagram illustrating a color moiré pattern resulting from a Bayer color filter array in an image sensor, in accordance with some examples of the present disclosure;

FIG. 5 is a block diagram illustrating an example artifact detection and correction engine, in accordance with some examples of the present disclosure;

FIG. 6A is an example image without high spectral frequency content, in accordance with some examples of the present disclosure;

FIG. 6B and FIG. 6C illustrate analysis of the example image without high frequency content of FIG. 6A by the frequency analysis engine of FIG. 5, in accordance with some examples of the present disclosure;

FIG. 7A is an example image with high spectral frequency content, in accordance with some examples of the present disclosure;

FIG. 7B and FIG. 7C illustrate analysis of the example image with high frequency content of FIG. 7A by the frequency analysis engine of FIG. 5, in accordance with some examples of the present disclosure;

FIG. 8 is a block diagram illustrating a blur level matching and motion estimation engine, in accordance with some examples of the present disclosure;

FIG. 9A is a block diagram illustrating a recursive image correction engine, in accordance with some examples of the present disclosure;

FIG. 9B is an additional block diagram illustrating a recursive image correction engine, in accordance with some examples of the present disclosure;

FIG. 10A through FIG. 10C are diagrams illustrating recursive image correction, in accordance with some examples of the present disclosure;

FIG. 11 is a flow diagram illustrating an example of an image processing technique, in accordance with some examples of the present disclosure;

FIG. 12 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

An image capture device (e.g., a camera) is a device that receives light and captures image frames, such as still images or video frames, using an image sensor. The terms “image,” “image frame,” “video frame,” and “frame” are used interchangeably herein. An image capture device typically includes at least one lens that receives light from a scene and bends the light toward an image sensor of the image capture device. The light received by the lens passes through an aperture controlled by one or more control mechanisms and is received by the image sensor. The one or more control mechanisms can control exposure, focus, and/or zoom based on information from the image sensor and/or based on information from an image processor (e.g., a host or application process and/or an image signal processor). In some examples, the one or more control mechanisms include a motor or other control mechanism that moves a lens of an image capture device to a target lens position.

Many image capture devices are configured to capture different portions of the electromagnetic spectrum (e.g., visible, infrared (IR), ultraviolet (UV), etc.). Devices that capture some or all of the visible spectrum are also be referred to as color image capture devices. Examples of color image capture devices include image capture devices that capture images including a red (R) component, a green (G) component, and a blue (B) component (collectively RGB) per pixel, image capture devices that capture images including luma, chroma-blue, and chroma-red (YUV, YCbCr, Y′CbCr, etc.) components per pixel, etc. For instance, RGB image capture devices utilize color filters to separate incoming light into different color light components. In one example, a Bayer color filter can filter incoming light into RGB light components and RGB photodiodes can capture corresponding RGB light to produce RGB signal values for each pixel in the sensor of the image capture device.

Cameras can be configured with a variety of image capture and image processing operations and settings. The different settings result in images with different appearances. Some camera operations are determined and applied before or during capture of the image, such as automatic focusing (AF), automatic exposure control (AEC), and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

In some cases, image sensors of a camera system can produce analog signals by generating electrons (e.g., current) in response to detecting light (e.g., photons). In some cases, the analog signals produced by the image sensors can be digitized by an analog-to-digital converter (ADC) to allow for image processing to be performed on digital data. In some cases, digitization of the analog signals can produce artifacts that can interfere with the image quality of an image captured by a camera system. For example, sampling of intricate patterns (e.g., fabric patterns, architecture), light emitting diode (LED) screens, sharp edges, and/or other patterns with high spatial frequencies can result in aliasing artifacts in captured images. In one illustrative example, aliasing artifacts can result in the appearance of moiré patterns. In some cases, the moiré patterns can produce a low spatial frequency pattern in an image as a result of under-sampling high spatial frequency features of a scene.

Various techniques exist for addressing the appearance of moiré patterns in captured images. For example, some camera systems (e.g., digital single lens reflex (DSLR)) camera systems may include optical anti-alias filters. However, such optical anti-alias can be costly and may not be suitable for some application. As another example, manual adjustments of camera settings (e.g., aperture, depth of field) and/or adjustments of the distance to a scene and/or angle of capture of a scene may be used to adjust signal frequency and reduce the appearance of moiré artifacts. However, such manual efforts require technique knowledge about operation of a camera as well as the source of moiré artifacts. In addition, various post-processing techniques such as selective blur, resampling, machine learning based techniques, and/or deep learning based techniques may be utilized to remove moiré artifacts from images. However, many such post-processing techniques can result in the loss of detail and/or blurred output relative to the focused input images. In view of the above, systems and techniques are needed for correcting image artifacts that can be done without degrading image quality, without requiring manual adjustment, and/or without the use of additional optical components.

Systems, apparatuses, processes (also referred to as methods), and computer-readable media (collectively referred to as “systems and techniques”) are described herein for correcting image artifacts. In some implementations, prior to applying artifact correction to an image, the systems and techniques can include analyzing the image to determine whether the image contains high frequency content. For example, analyzing the image can include performing a Fourier transform, such as a discrete Fourier transform (DFT) to detect high frequency components in the image. In some cases, artifact correction can be performed when high frequency components are detected in an image. However, in some cases, artifact correction may be bypassed when high frequency components are not detected in the image. Accordingly, the systems and techniques can avoid unnecessary processing on images that do not contain visual artifacts caused by high frequency components.

In some cases, aliasing artifacts caused by high frequency components (e.g., moiré patterns) in captured images may disappear when defocused images of a scene are captured. For example, by defocusing images of a scene, high frequency spatial components of the scene can be blurred together and as a result may disappear. However, such defocus can also remove desired detail in captured images of the scene. As used herein, the degree to which a captured image is defocused is hereinafter referred to as a “blur level.” In some cases, images with different blur levels can be captured by automatically capturing one or more defocused images after capturing a focused image. For example, one or more images captured by an AF lens at different lens positions can be captured to obtain multiple images of a scene with different blur levels. In some cases, multiple images of a scene may be captured automatically as part of an AF operation. In one illustrative example, multiple images with different focus levels from an AF operation may be stored in an image buffer (e.g., a zero shutter lag (ZSL) queue). In some cases, it can be desirable for each of the defocused images of the scene to include the entire field of view (FOV) captured in the focused image. In some implementations, defocused images captured while moving the AF lens to capture a larger FOV than the focused image can be utilized for artifact correction. In some places, an image with the maximum amount of defocus (e.g., maximum blur level) can be captured to minimize and/or completely remove moiré pattern artifacts.

In some cases, a first image with a first blur level that includes visual artifacts (e.g., moiré patterns) can be corrected using a second image with a second blur level (e.g., a blur level greater than the first blur level) that is devoid of visual artifacts. In some cases, applying artifact correction to the first image can include blurring the first image generate a blurred first image with the second blur level. In some cases, a blur kernel can be applied generate the blurred first image based on the first image. In one illustrative example, the blur kernel can apply a depth based circular blur to the first image. In some aspects, the blur kernel can have a shape that matches the aperture shape. For example, if a camera has a circular aperture, a circular blur kernel may be utilized. As another example, if a camera has an oval aperture, an oval blur kernel may be utilized. In some implementations, the kernel size applied to pixels of a particular image may be based on pixel depth, camera intrinsic parameters, difference in AF lens position between frames, and/or any combination thereof.

In some cases, a difference map can be generated between the blurred first image and the second image. In some aspects, the residual signal in the difference map can represent the high frequency artifacts in the first image. In some examples, correcting the first image can include subtracting the difference map from the first image to generate a corrected first image.

In some implementations, motion estimation can be performed to ensure that the blurred first image and the second image are aligned prior to generating the difference map. In some cases, the motion estimation can include extracting features from the blurred first image and the second image and determining a warping matrix that aligns the extracted features. In some cases, the warping matrix can be applied to the second image (e.g., the image with the greater amount of blur).

In some cases, a plurality of images with differing blur levels can be used perform a recursive image correction process. For example, an image from an AF sequence with the maximum blur level may be utilized to correct an image with an incrementally lower blur level. In some cases, corrections can be applied to successive images with incrementally lower blur levels until a correction is applied to the focused image. In some aspect, such an incremental approach can be used to reduce the amount of blurring required to match blur levels between a pair of images used at each stage of the correction process. In some cases, such an incremental approach can improve the image quality of the corrected focused image after artifact correction.

Various aspects of the application will be described with respect to the figures.

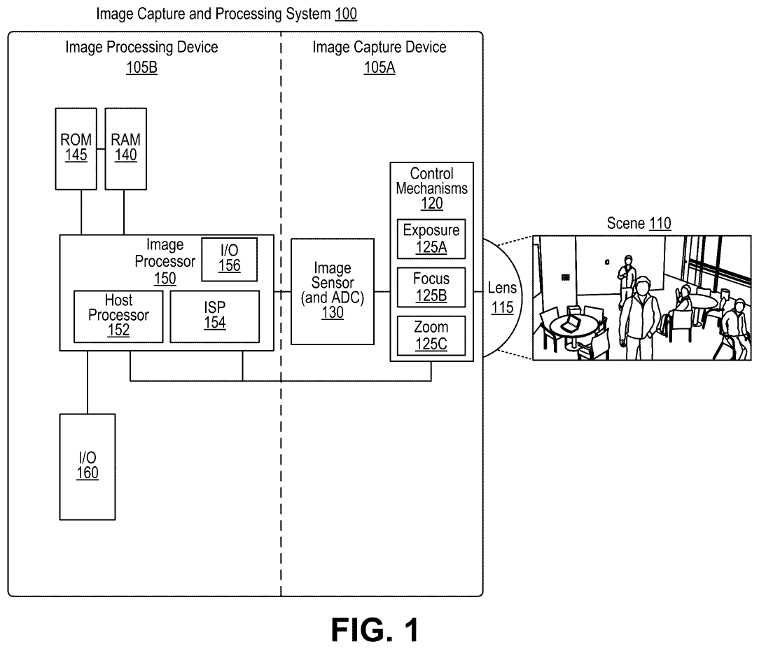

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), time of flight (ToF), structured light, stereoscopy, or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image capture and processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an ADC to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

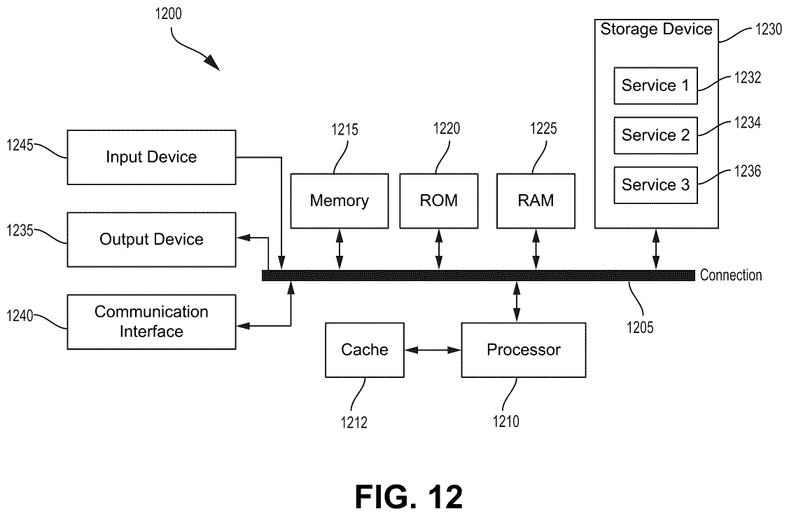

The image processor 150 may include one or more processors, such as one or more image signal processors (ISPs) (including ISP 154), one or more host processors (including host processor 152), and/or one or more of any other type of processor 1210 discussed with respect to the computing system 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), GPUs, broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1225, read-only memory (ROM) 145/1220, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image processing device 105B, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1002.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more or fewer components than those shown in FIG. 1. In some cases, the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

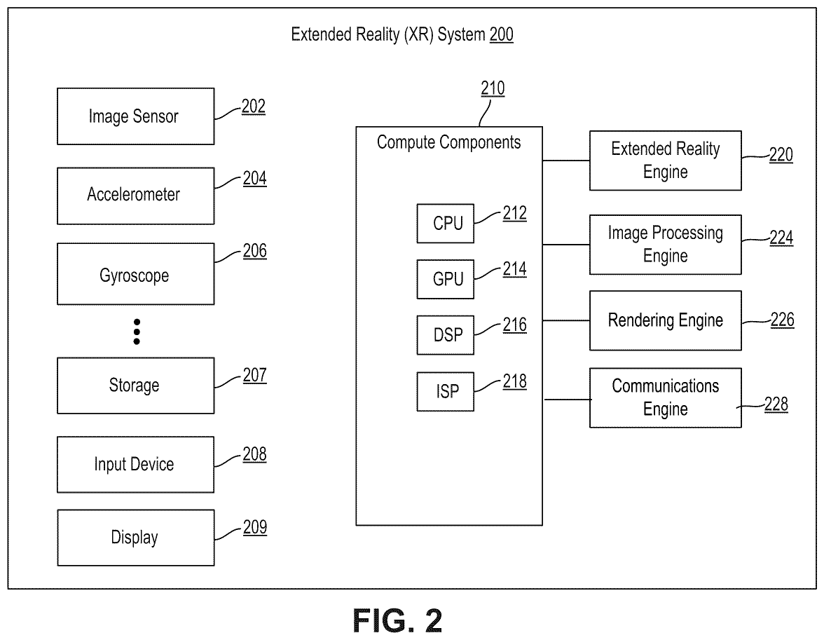

In some examples, the XR system 200 of FIG. 2 can include the image capture and processing system 100, the image capture device 105A, the image processing device 105B, or a combination thereof.

FIG. 2 is a diagram illustrating an architecture of an example XR system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., 3D map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, less, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1245 discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1240 of FIG. 12.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a 3D map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or SLAM techniques. For instance, the compute components 210 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

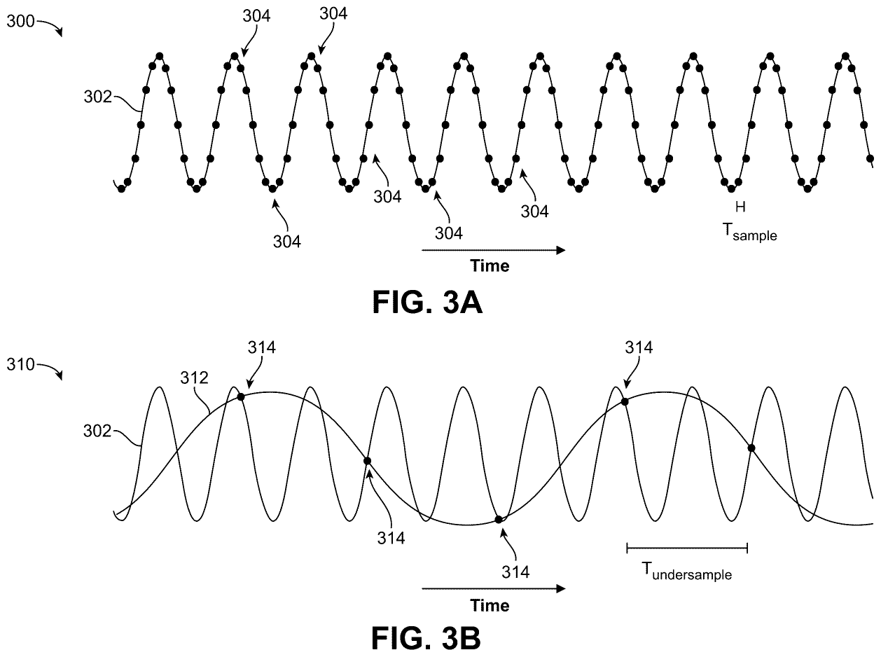

FIG. 3A illustrates an example plot 300 of a waveform 302 sampled with a sampling rate capable of reproducing the waveform. In the plot 300, the horizontal axis represents time, and the vertical axis represents amplitude. In the example of FIG. 3A, the waveform 302 may represent an analog sinusoidal signal with a frequency f As illustrated in FIG. 3A, the waveform 302 can be sampled (e.g., digitally sampled) at sampling points 304. A sampling period Tₛₐₘₚₗₑ associated with the sampling points 304 can correspond to a sampling frequency of

$${f}_{s a m p l e} = \frac{1}{{T}_{s a m p l e}} .$$

According to the Nyquist theorem, a sine wave with frequency f can be accurately reproduced if fₛₐₘₚₗₑ≥2f, where 2f is referred to as the Nyquist frequency. In the sample of FIG. 3A, the sampling frequency fₛₐₘₚₗₑ exceeds the Nyquist frequency and therefore the sampling points 304 can be used to accurately reproduce the waveform 302.

FIG. 3B illustrates an example plot 310 of undersampling the waveform 302 of FIG. 3A. As described above, the waveform 302 may represent an analog sinusoidal signal with a frequency f As illustrated in FIG. 3A, the waveform 302 can be sampled (e.g., digitally sampled) at sampling points 314. A sampling period T_{undersample} associated with the sampling points 314 can correspond to a sampling frequency of

$${f}_{u n d e r s a m p l e} = \frac{1}{{T}_{u n d e r s a m p l e}} .$$

In the example of FIG. 3B, f_{undersample}<2f and as a result the reproduced waveform 312 based on the sampling points 314 appears to have a lower frequency than the original waveform. In some cases, the misrepresentation and/or misidentification of a signal frequency caused by undersampling is known as aliasing.

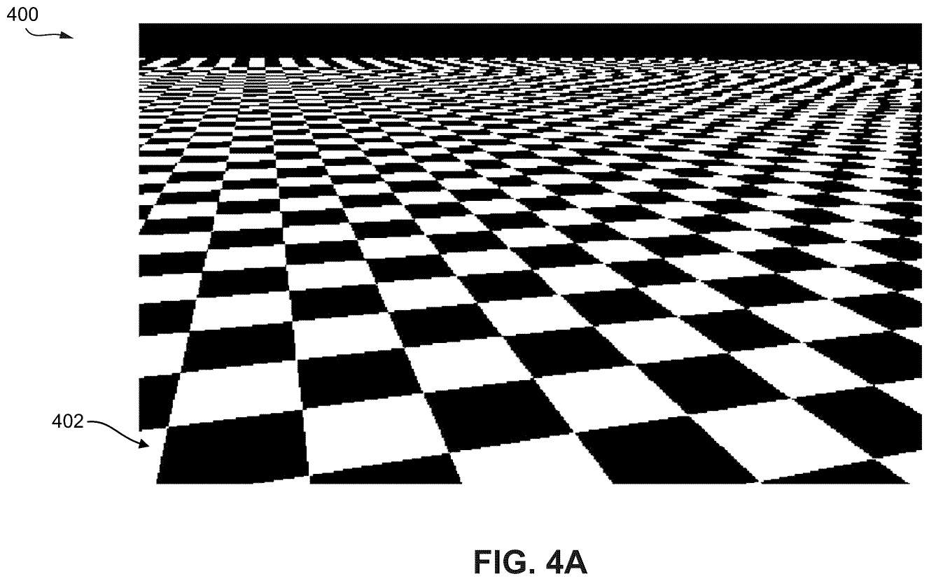

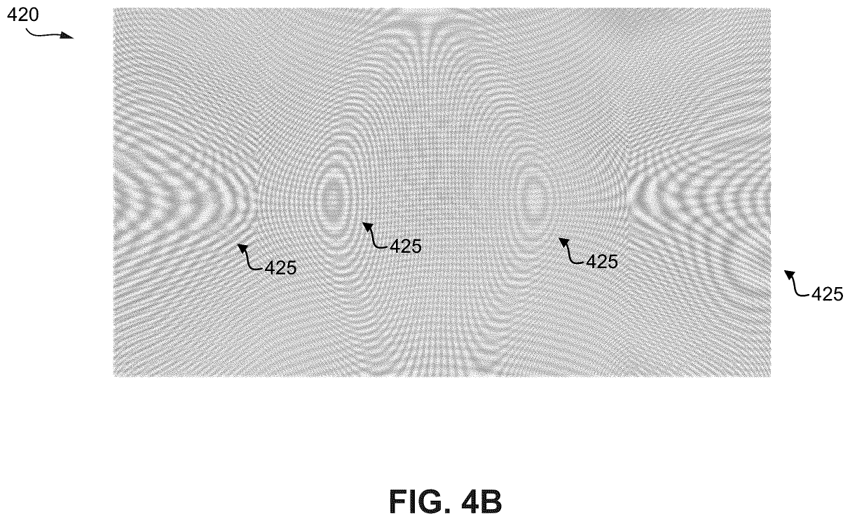

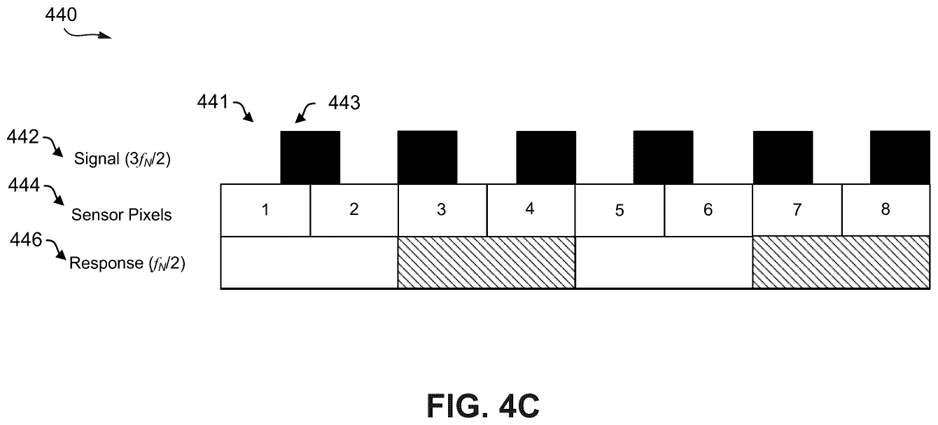

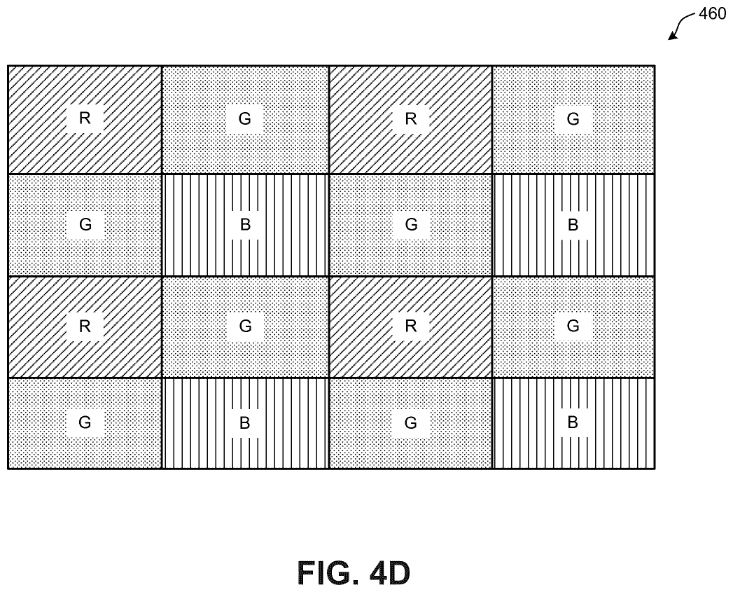

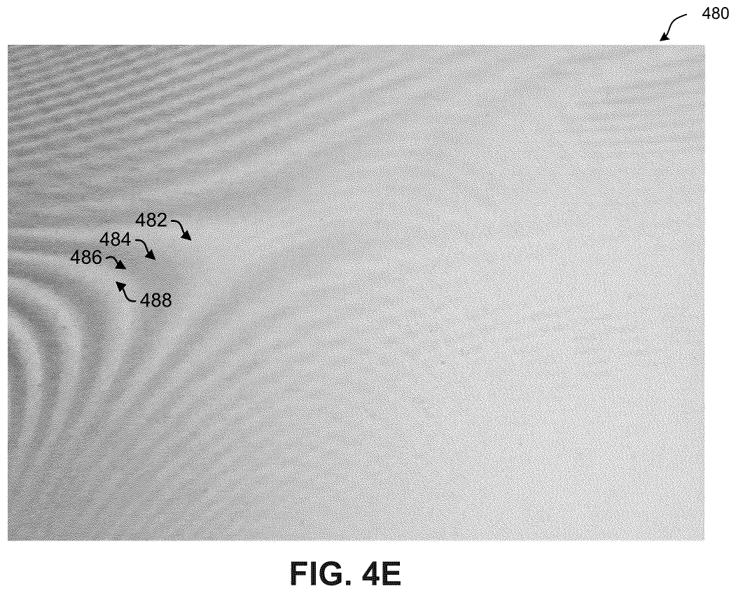

FIG. 4A includes an image 400 illustrating an example of aliasing. In the example of FIG. 4A, a representation of a checkerboard pattern includes jagged edges 402 in a stair-step pattern where the original checkboard pattern edges are smooth. The jagged edges 402 can be a result of aliasing due to undersampling.

FIG. 4B includes an image 420 that illustrates an example moiré pattern. In some cases, moiré patterns appear as false ripples or waves of luminosity and/or color intensity variation across an image. For example, image 420 illustrates various ripple patterns 425 that may appear in an image that includes a moiré pattern. In some cases, capturing subjects with repetitive patterns, intricate patterns (e.g., fabrics or architecture) and/or capturing images of LED screens can produce moiré patterns.

FIG. 4C is a diagram 440 illustrating aliasing of a signal waveform 442 captured by a subset of eight pixels 444 of an image sensor. As illustrated in FIG. 4C, the signal waveform 442 can include an alternating pattern of white 441 and black 443 with a signal frequency of

$$\frac{3 {f}_{N}}{2} ,$$

where f_{N} is the Nyquist frequency of the image sensor. In some aspects, the Nyquist frequency of an image sensor is 0.5 cycles per pixel. As shown in FIG. 4C, the response 446 of the eight pixels 444 resulting from the signal waveform 442 can exhibit a frequency of

$$\frac{{f}_{N}}{2} ,$$

which is one third the frequency of the signal waveform 442. Accordingly, the response 446 is an aliased representation of the signal waveform 442.

An example of a Bayer color filter array 460 is shown in FIG. 4D. As illustrated in FIG. 4D, the Bayer color filter array 460 includes a repeating pattern of R color filters, B color filters, and G color filters. The pattern of the Bayer color filter array 460 shown in FIG. 4D, can be repeated for the entire array of photodiodes of a given image sensor (e.g., image sensor 130 of FIG. 1). In some cases, pixel information from adjacent pixels (e.g., one red, one blue, and two green pixels) can be combined to produce the color information of a single pixel in an image. In some cases, the spacing between pixels of the same color within the Bayer color filter array 460 can be larger than the spacing between pixels in the final image, which can result in a lower effective Nyquist frequency. In some cases, the Bayer color filter array 460 can produce an image with a color moiré pattern as illustrated in image 480 of FIG. 4E. In the illustrated example of FIG. 4E, the image 480 contains a moiré pattern that includes bands of color, where the lightest portions may have a green 482 appearance, which can transition to red 484 and further transition to blue 486 before returning to green 488 at a different portion of the moiré pattern.

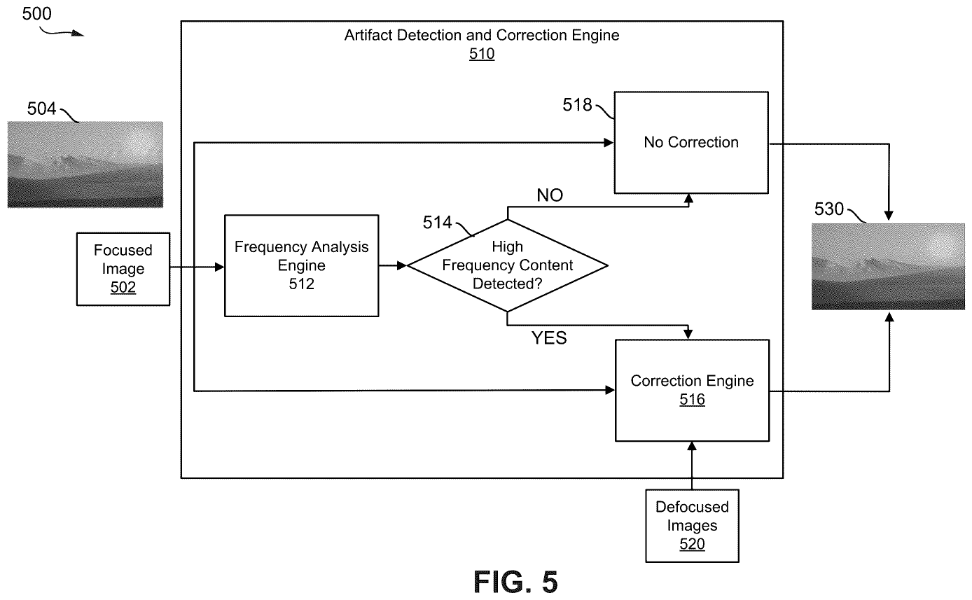

FIG. 5 is a diagram 500 illustrating an example configuration for performing artifact detection and correction of moiré artifacts. As illustrated in FIG. 5, an artifact detection and correction engine 510 can obtain a focused image 502, determine whether the focused image contains moiré artifacts, correct the focused image if moiré artifacts are present, and produce an output image 530 that is devoid of moiré artifacts and/or have reduced appearance of moiré artifacts. As shown in FIG. 5, the focused image 502 can be provided to a frequency analysis engine 512. The frequency analysis engine 512 can be configured to determine whether the focused image 502 contains high spectral frequency content.

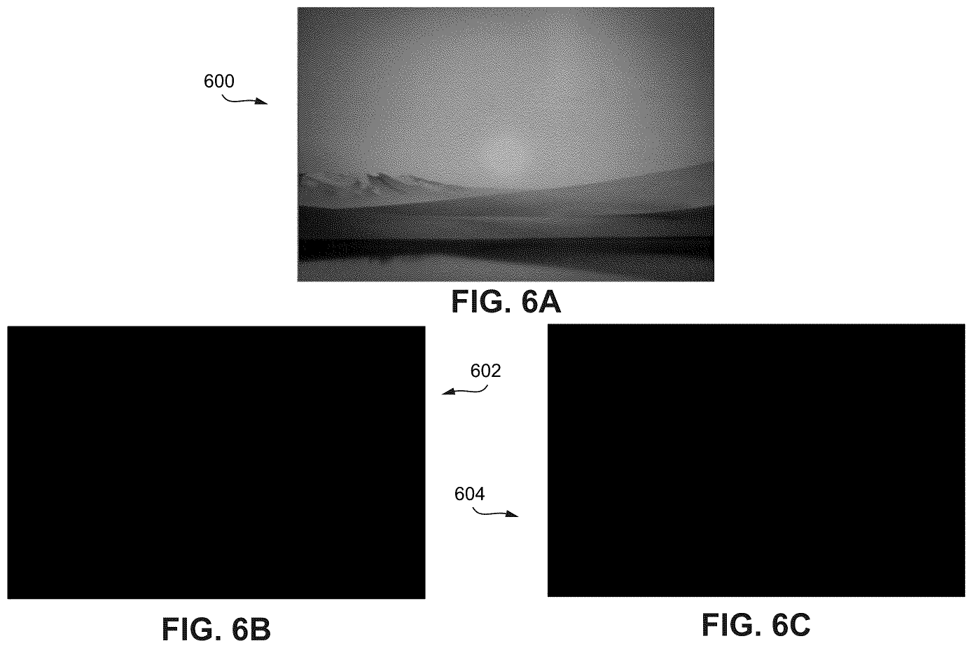

FIG. 6A through FIG. 6C illustrate an example frequency detection operation performed by the frequency analysis engine 512 on an image that lacks high spectral frequency content. As shown in FIG. 6A, the focused image 600 (e.g., focused image 502 of FIG. 5) is devoid of moiré artifacts. Accordingly, the high frequency content map 602 of FIG. 6B can result from applying a high pass filter to the DFT performed by the frequency analysis engine 512 of FIG. 5 exhibits no high spectral frequency content (as indicated by the black image). Similarly, the binned high spectral frequency component map 604 of FIG. 6C exhibits no high spectral frequency content (as indicated by the black image).

Returning to FIG. 5, if the artifact detection and correction engine 510 determines at the decision block 514 that no high frequency content was detected in the focused image 502 by the frequency analysis engine 512, the artifact detection and correction engine 510 can forego correcting the focused image 502 by the correction engine 516 as indicated by the no correction block 518 of FIG. 5. Accordingly, the output image 530 can be the original focused image 502 without any modification.

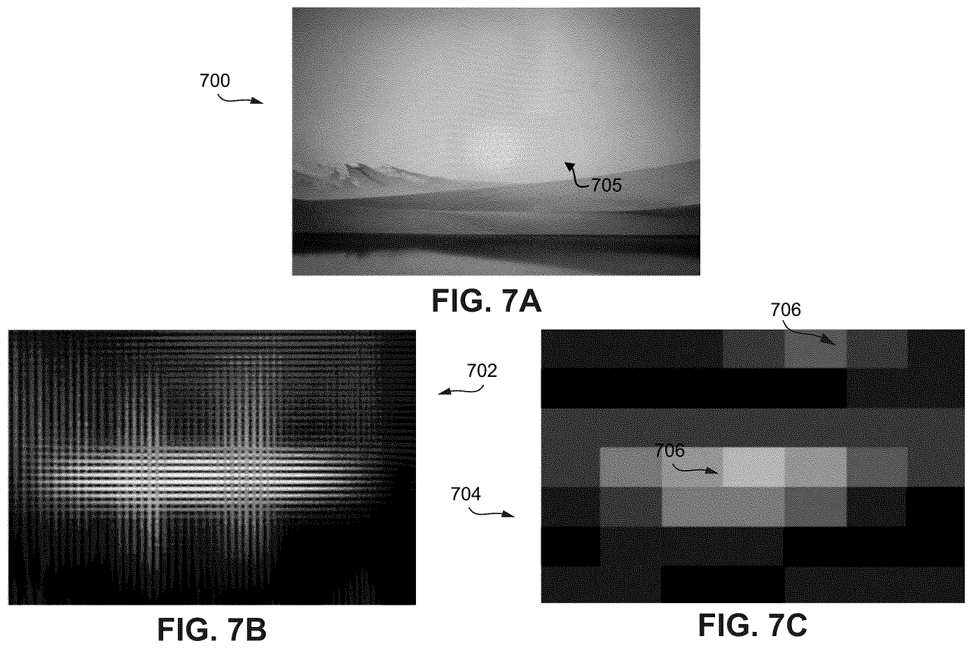

FIG. 7A through FIG. 7C illustrate an example frequency detection operation performed by the frequency analysis engine 512 on an image that contains high spectral frequency content. As illustrated in FIG. 7A, a focused image 700 (e.g., focused image 502 of FIG. 5) may include moiré artifacts 705 (e.g., a moiré pattern). In some implementations, the frequency analysis engine 512 of FIG. 5 may perform a DFT on the focused image 700. In some examples, the frequency analysis engine 512 of FIG. 5 can apply a high pass filter which applies a non-zero value (e.g., a white color, a binary “true” value, or the like) to any pixel position in the DFT output that includes spectral frequency components above a frequency threshold (e.g., above the Nyquist frequency) and applies a zero value (e.g., a black color, a binary “false” value, or the like) to any other pixel position in the DFT output to produce the high spectral frequency content map 702 of FIG. 7B. In some implementations, the high spectral frequency content map 702 can be grouped into a grid wherein each region 706 of the grid includes a sum of the pixels within the respective region 706 that includes high spectral frequency content. For example, each region 706 of the grid map 704 can correspond to a number of pixels within the respective region that contains high frequency spectral content. In some implementations, a score can be assigned to each grid map 704 to determine whether the focused image 700 includes sufficient high spectral frequency content to require artifact correction. Equation (1) below provides an illustrative example of a score calculation for assessing the amount of high spectral frequency content in the focused image 700.

$$score = {\sum }_{k = 0}^{n} {w}_{k} * {x}_{k} \qquad ( 1 )$$

Where n is the number of regions 706 in the grid map 704, k is an index, wₖ is a weighting factor applied to each respective region, and xₖ is the grid sum for a particular region. In some cases, the weighting factor wₖ can depend on the distance between the region k and a focus region of interest for the camera.

If the frequency analysis engine 512 determines at the decision block 514 that the focused image 502 (e.g., focused image with high spectral frequency content 504) does contain high spectral frequency content (e.g., based on the score of Equation (1)), the correction engine 510 can pass the focused image 502 and one or more defocused images 520 of the same scene as the focused image 502 to the correction engine 516.

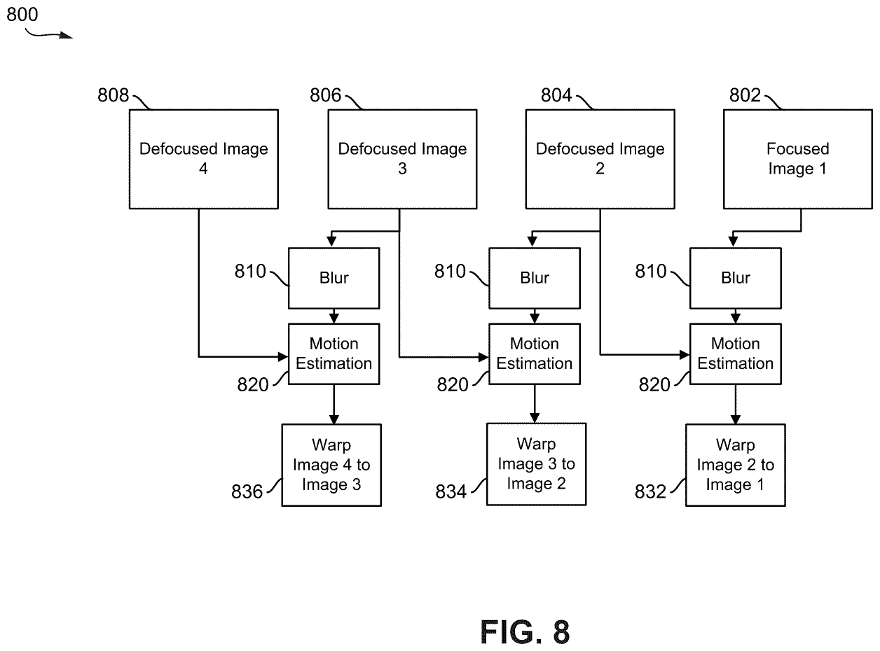

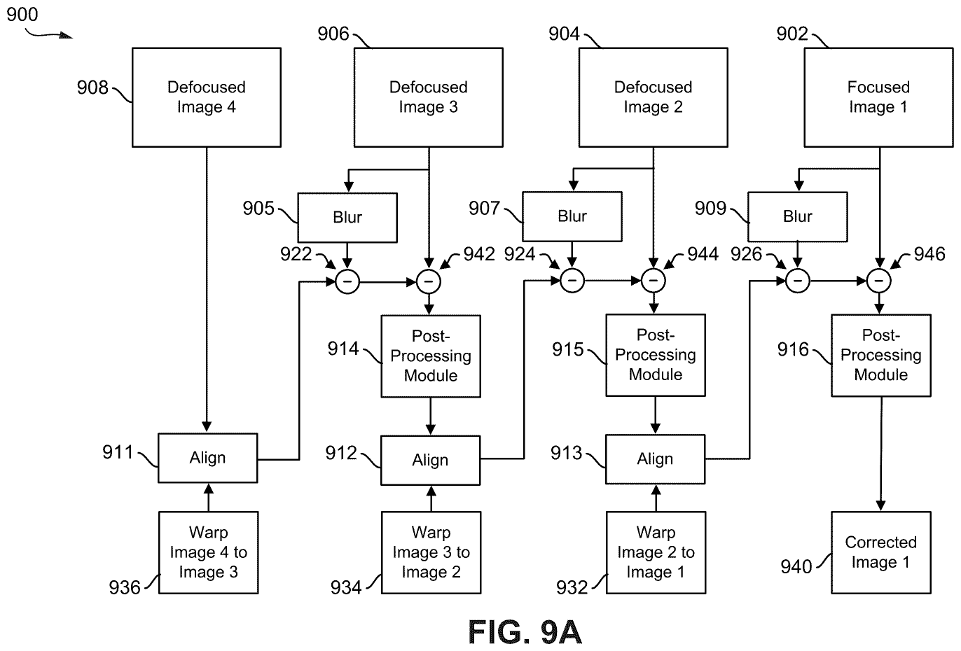

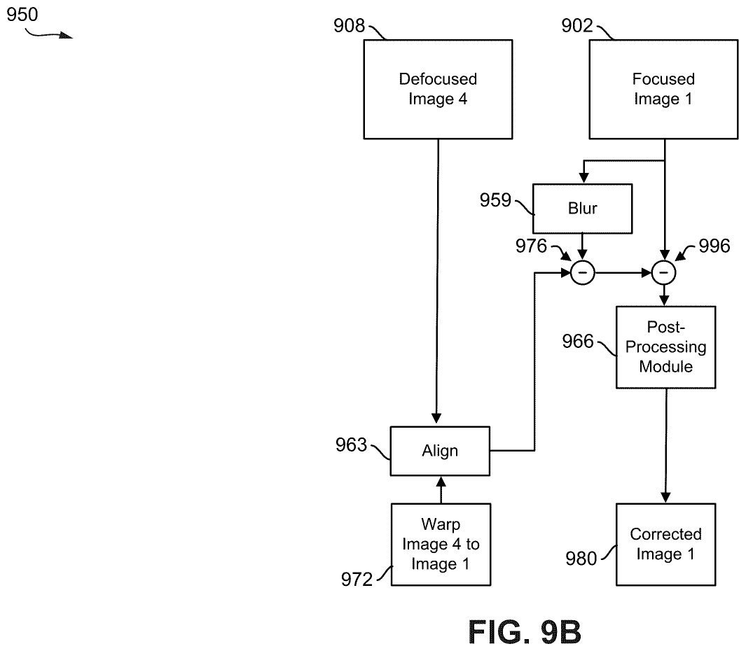

In some implementations, the correction engine 516 can include a blur level matching and estimation engine (e.g., blur level matching and motion estimation engine 800 of FIG. 8) and a recursive image correction engine (e.g., recursive image correction engine 900 of FIG. 9A).

FIG. 8 is a block diagram illustrating a blur level matching and motion estimation engine 800. In some implementations, the blur level matching and motion estimation engine 800 may be included in the correction engine 516 of FIG. 5. In the example of FIG. 8, four images 802, 804, 806, 808 can be captured as part of an image artifact correction capture sequence. As illustrated, the focused image 802 (also referred to as focused image 1) can be a focused image of a scene. In some cases, defocused image 804 (also referred to as defocused image 2) can have a first blur level while the focused image 802 has a blur level as close to zero as possible. In some examples, defocused image 806 (also referred to as defocused image 3) can have a second blur level that is greater than the first blur level. In some aspects, defocused image 808 (also referred to as defocused image 4) can have a third blur level that is greater than the second blur level. In some examples, the defocused image 808 can have the maximum blur level that can be achieved by an AF lens. In some cases, by capturing defocused image 808 with the maximum blur level that can be achieved by the AF lens, the defocused image 808 may have the highest likelihood of being free of moiré artifacts.

In some cases, the direction of movement of the AF lens to achieve increasing amounts of defocus can also result in increasingly large FOV. For example, the focused image 802 may have the smallest FOV, the defocused image 804 can have a larger FOV than the focused image 802, the defocused image 806 can have a larger FOV than the defocused image 804, and the defocused image 808 may have the largest FOV

As illustrated in FIG. 8, a blur engine 810 may be used to achieve a blur level matching the blur level of the defocused image 808. In some cases, the blur engine 810 can apply a blur to generate a blurred version an input image. In one illustrative example, blur engine 810 can apply a depth based circular blur kernel to the defocused image 806. In some aspects, the blur kernel can have a shape that matches the aperture shape of the camera used to capture the images 802, 804, 806, 808. For example, the capturing camera has a circular aperture, the blur engine 810 may utilize a circular blur kernel. As another example, if the capturing camera has an oval aperture, the blur engine 810 may utilize an oval blur kernel. In some implementations, the kernel size applied to pixels of a particular image may be based on pixel depth, camera intrinsic parameters, difference in AF lens position between frames, and/or any combination thereof.

In the example of FIG. 8, the blur engine 810 applies a blur kernel to the defocused image 806 to generate a blurred version of the defocused image 806 that has a blur level matching the blur level of the defocused image 808.

As illustrated in FIG. 8, the blurred version of the defocused image 806 and the defocused image 808 can be provided to a motion estimation engine 820. In some implementations, the motion estimation engine 820 may utilize a feature based motion estimation. In one illustrative example, a feature based motion estimation can include extracting features from each of the blurred version of the defocused image 806 and the defocused image 808. In some cases, by matching the blur level in the blurred version of the defocused image 806 and the defocused image 808, features present in each of the respective images may be used to perform motion estimation to compensate for FOV changes. For example, FOV changes may be caused by AF lens motion between captures, camera motion between captures, and/or any combination thereof.

In some implementations, one or more computer vision-based feature extraction techniques can be used by the motion estimation engine 820, such as using Histogram of oriented gradients (HOG), Speeded-up robust features (SURF), Local binary patterns (LBP), Haar wavelets, Color histograms, any combination thereof, and/or other computer vision techniques. In some implementations, the feature detection and/or recognition algorithm can be based on a machine learning model trained to extract features from images. For instance, the machine learning model can be a neural network (NN), such as a convolutional neural network (CNN), a time delay neural network (TDNN), a deep feed forward neural network (DFFNN), a recurrent neural network (RNN), an auto encoder (AE), a variation AE (VAE), a denoising AE (DAE), a sparse AE (SAE), a markov chain (MC), a perceptron, or some combination thereof. The machine learning model may be trained using supervised learning techniques, unsupervised learning techniques, semi-supervised learning techniques, any combination thereof, Generative adversarial network (GAN) training techniques, and/or other machine learning training techniques.

In some examples, the motion estimation engine 820 can perform feature matching to determine a corresponding between features extracted from the blurred version of the defocused image 806 and the features extracted from the defocused image 808. In some cases, the motion estimation engine 820 can generate a warping matrix 836 for warping the defocused image 808 to align with the blurred version of the defocused image 806.

For example, the warping matrix 836 may be a 3×3 homography matrix for projective as illustrated by Equation (2) below:

$$[ \begin{matrix}{x}_{1} \\ {y}_{1} \\ 1\end{matrix} ] = H [ \begin{matrix}{x}_{2} \\ {y}_{2} \\ 1\end{matrix} ] = [ \begin{matrix}{h}_{00} & {h}_{01} & {h}_{02} \\ {h}_{10} & {h}_{11} & {h}_{12} \\ {h}_{20} & {h}_{21} & {h}_{22}\end{matrix} ] [ \begin{matrix}{x}_{2} \\ {y}_{2} \\ 1\end{matrix} ] \qquad ( 2 )$$

Where (x₂, y₂) are coordinates in the image being aligned (e.g., defocused image 808), H is the 3×3 homography matrix, and (x₁, y₁) are coordinates in the aligned image.

As illustrated in FIG. 8, the blur level matching and motion estimation engine 800 can perform a similar process of blurring defocused image 804 to generate a blurred version of defocused image 804 with a blur level matching the defocused image 806 using a blur engine 810. In some examples, a motion estimation engine 820 may perform motion estimation on the blurred version of defocused image 804 and the defocused image 806 to determine a warping matrix 834 for warping the defocused image 806 to align with the blurred version of the defocused image 804.

As further illustrated in FIG. 8, the blur level matching and motion estimation engine 800 can perform a similar process of blurring focused image 802 to generate a blurred version of focused image 802 with a blur level matching the defocused image 804 using a blur engine 810. In some examples, a motion estimation engine 820 may perform motion estimation on the blurred version of focused image 802 and the defocused image 804 to determine a warping matrix 832 for warping the defocused image 806 to align with the blurred version of the focused image 802.

FIG. 9A is a block diagram illustrating a recursive image correction engine 900. In some cases, the recursive image correction engine 900 may be included in the correction engine 516 of FIG. 5. In the example of FIG. 9A, four images 902, 904, 906, 908 can be captured as part of an image artifact correction capture sequence. In some aspects, the four images 902, 904, 906, 908 can correspond to the four images 802, 804, 806, 808 of FIG. 8, respectively. As illustrated, the focused image 902 (also referred to as focused image 1) can be a focused image of a scene. In some cases, defocused image 904 (also referred to as defocused image 2) can have a first blur level while the focused image 902 has a blur level as close to zero as possible. In some examples, defocused image 906 (also referred to as defocused image 3) can have a second blur level that is greater than the first blur level. In some aspects, defocused image 908 (also referred to as defocused image 4) can have a third blur level that is greater than the second blur level. In some examples, the defocused image 908 can have the maximum blur level that can be achieved by an AF lens. In some cases, by capturing defocused image 908 with the maximum blur level that can be achieved by the AF lens, the defocused image 908 may have the highest likelihood of being free of moiré artifacts. In some cases, one or more of the defocused image 906, the defocused image 904, or the focused image 902 may exhibit moiré artifacts.

In some cases, the direction of movement of the AF lens to achieve increasing amounts of defocus can also result in increasingly large FOV. For example, the focused image 902 may have the smallest FOV, the defocused image 904 can have a larger FOV than the focused image 902, the defocused image 906 can have a larger FOV than the defocused image 904, and the defocused image 908 may have the largest FOV

In some cases, the blur engine 905 may be similar to and perform similar functions to the blur engine 810 of FIG. 8. As illustrated, the blur engine 905 may generate a blurred version of the defocused image 906.

In some cases, the recursive image correction engine 900 can obtain warping matrices 932, 934, 936 for aligning images from the blur level matching and motion estimation engine 800 of FIG. 8. The warping matrices 932, 934, 936 can correspond to the warping matrices 832, 834, 836 of FIG. 8, respectively.

As illustrated in FIG. 9A, an alignment engine 911 may utilize the warping matrix 936 to warp the defocused image 908 to align with a blurred version of the defocused image 906. In some examples, the alignment engine 911 may crop the warped version of the defocused image 908 to match the FOV of the blurred version of defocused image 906.

In some case, a difference engine 922 may determine a difference map between the blurred version of the defocused image 906 and the aligned version of the defocused image 908. In some cases, the content of a difference map output from the difference engine 922 can represent the moiré artifacts present in the defocused image 906 but absent from the defocused image 908. In some implementations, a difference engine 942 can remove the contents of the difference map output by the difference engine 922 from the defocused image 906 to obtain a corrected version of the defocused image 906 without artifacts.

In some cases, a post-processing module 914 may perform additional processing on the corrected version of the defocused image 906 output from the difference engine 942. In some cases, the post-processing module 914 may apply a gaussian blur filter (e.g., a 3×3 gaussian blur filter) to remove fine details of a captured image (e.g., pixel level LED screen details of a captured LED screen) that could cause moiré artifacts. In some cases, the post-processing module 914 may apply a sharpening filter after application of the gaussian filter to restore details in the image that would otherwise be blurred by the gaussian blur filter.

In some aspects, the output of post-processing module 914 can represent a corrected version of defocused image 906 with moiré artifacts removed while maintaining details of the captured scene contained in the defocused image 906 prior to correction.

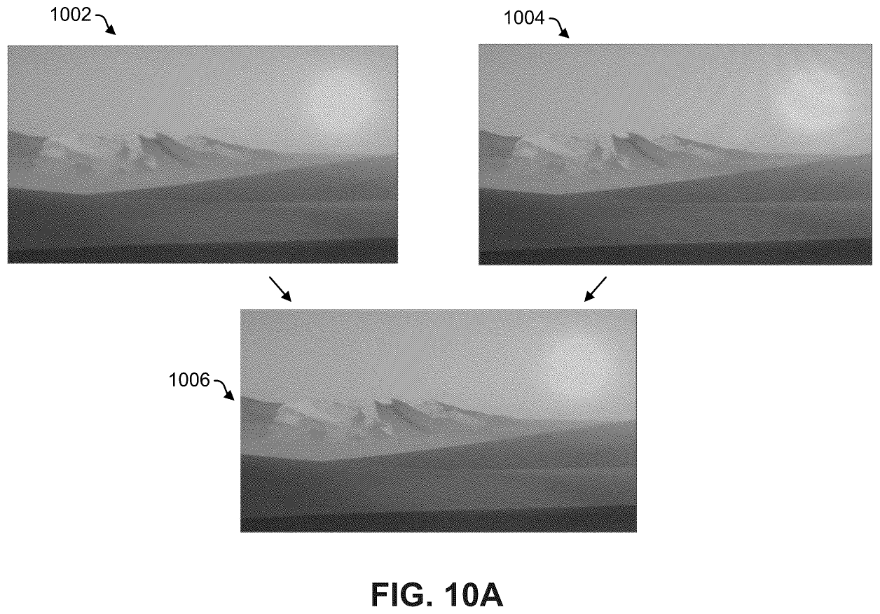

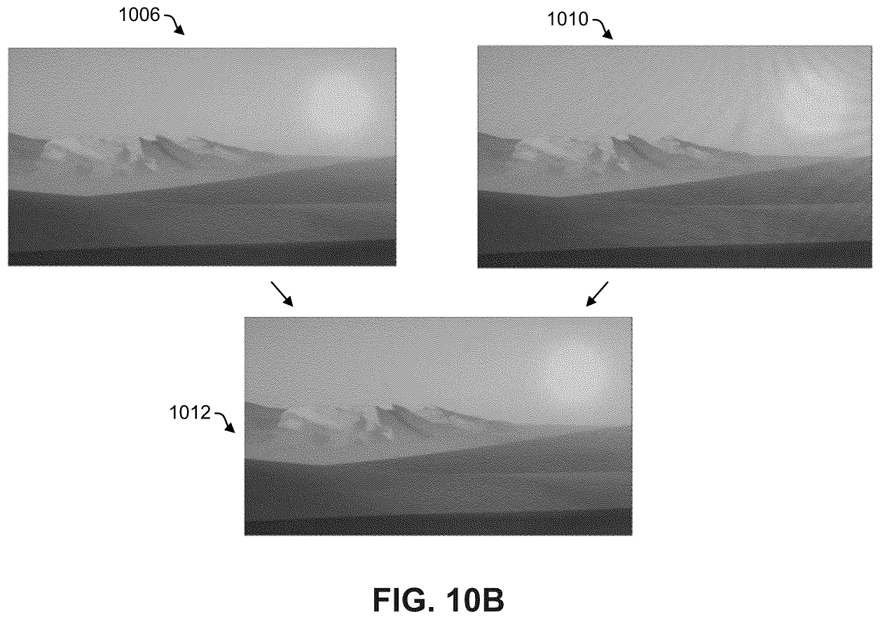

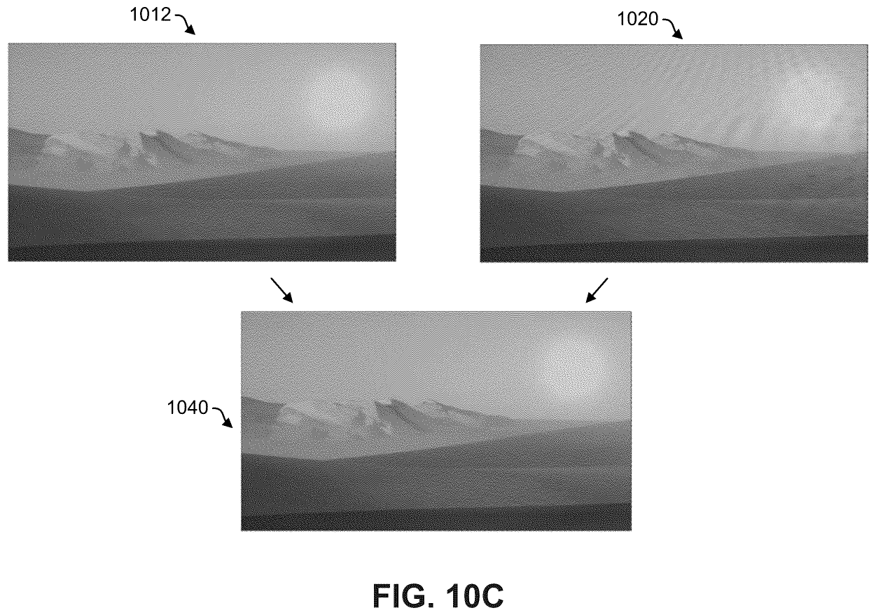

Referring to FIG. 10A, the defocused image 1002 can correspond to the defocused image 808 after alignment by the alignment engine 911 of FIG. 9A and the defocused image 1004 can correspond to the defocused image 906. As shown in FIG. 10A, the defocused image 1004 exhibits a moiré pattern. However, after correction of the defocused image 1004 using the defocused image 1002, the resulting corrected defocused image 1006 (e.g., output of the post-processing module 914 of FIG. 9A) can be devoid of moiré artifacts while maintaining the blur level (and corresponding level of detail) of the defocused image 1004 prior to correction.

Returning to FIG. 9A, in some aspects, the relationship between the corrected version of defocused image 906 output from the post-processing module 914 and the defocused image 904 can be analogous to the relationship between the defocused image 908 and the defocused image 906 prior to correction of the defocused image 906.

Accordingly, a similar process can be utilized to correct the defocused image 904 based on the corrected version of the defocused image 906. For example, the blur engine 907 can generate a blurred version of the defocused image 904 having a blur level that matches the blur level of the corrected version of the defocused image 906. In some cases, the alignment engine 912 may utilize the warping matrix 934 (e.g., a 3×3 homography matrix as shown in Equation (2)) to align the corrected version of defocused image 906 with the blurred version of the defocused image 904. In some implementations, the difference engine 924 may generate a difference map between the corrected version of defocused image 906 and the blurred version of the defocused image 904 and the output of the difference engine 924 can correspond to the moiré pattern present in the defocused image 904 but absent in the corrected version of the defocused image 906. In some examples, the difference engine 944 can remove the contents of the difference map output by the difference engine 924 from the defocused image 904 to obtain a corrected version of the defocused image 904 without artifacts. In some cases, the post-processing module 915 can perform post processing similar to the post-processing module 914.

Referring to FIG. 10B, the defocused image 1006 (e.g., output of the post-processing module 914 of FIG. 9A) of FIG. 10A is reproduced in the position originally occupied by the defocused image 1002 in FIG. 10A. In some aspects, the defocused image 1010 can correspond to defocused image 904 of FIG. 9A. As shown in FIG. 10B, the defocused image 1010 exhibits a moiré pattern. However, after correction of the defocused image 1010 using the defocused image 1006, the resulting corrected defocused image 1012 (e.g., output of the post-processing module 915 of FIG. 9A) can be devoid of moiré artifacts while maintaining the blur level (and corresponding level of detail) of the defocused image 1010 prior to correction.

In some aspects, the relationship between the corrected version of defocused image 904 output from the post-processing module 915 and the focused image 902 can be analogous to the relationship between the defocused image 906 and the defocused image 904 prior to correction of the defocused image 904.

Accordingly, a similar process can be utilized to correct the focused image 902 based on the corrected version of the defocused image 904. For example, the blur engine 909 can generate a blurred version of the focused image 902 having a blur level that matches the blur level of the corrected version of the defocused image 904. In some cases, the alignment engine 913 may utilize the warping matrix 932 (e.g., a 3×3 homography matrix as shown in Equation (2)) to align the corrected version of defocused image 904 with the blurred version of the focused image 902. In some implementations, the difference engine 926 may generate a difference map between the corrected version of defocused image 904 and the blurred version of the focused image 902 and the output of the difference engine 926 can correspond to the moiré pattern present in the focused image 902 but absent in the corrected version of the defocused image 904. In some examples, the difference engine 946 can remove the contents of the difference map output by the difference engine 926 from the focused image 902 to obtain a corrected focused image 940 (e.g., a corrected version of the focused image 902 without artifacts). In some cases, the post-processing module 916 can perform post processing similar to the post-processing module 914.

Referring to FIG. 10C, the defocused image 1012 (e.g., output of the post-processing module 915 of FIG. 9A) of FIG. 10B is reproduced in the position originally occupied by the defocused image 1006 in FIG. 10B. In some aspects, the focused image 1020 can correspond to focused image 902 of FIG. 9A. As shown in FIG. 10C, the focused image 1020 exhibits a moiré pattern. However, after correction of the focused image 1020 using the defocused image 1012, the resulting corrected focused image 1040 (e.g., output of the post-processing module 916 of FIG. 9A) can be devoid of moiré artifacts while maintaining the focus (and corresponding level of detail) of the focused image 1020 prior to correction.

In some cases, the blur levels of the defocused images 904, 906, 908 can be selected such that the difference in blur level between a pair of images used for artifact correction does not exceed a threshold blur level difference.

FIG. 9B is an additional block diagram illustrating a recursive image correction engine 950. The example of FIG. 9B illustrates a scenario in which the defocused image 908 (e.g., the image with maximum possible defocus of an AF lens) is used to directly correct the focused image 902. As illustrated, the defocused image 908 can be aligned by an alignment engine 963 using a warping matrix 972 (e.g., generated by the blur level matching and motion estimation engine 800 of FIG. 8). In the example of FIG. 9B, the blur engine 959 can apply a blur kernel to generate a blurred version of the focused image 902 with a blur level matching the blur level of the defocused image 908. However, if the difference in blur level between the defocused image 908 and the focused image 902 exceeds the threshold blur level difference, the blur kernel applied by the blur engine 959 may blur the focused image 902 to such an extent that the moiré artifacts are no longer present in the blurred version of the focused image 902. Accordingly, the difference map output by the difference engine 976 would no longer be representative of the moiré artifacts present in the focused image 902. In some cases, the difference map output by the difference engine 976 may produce additional artifacts when subtracted by the difference engine 996 from the focused image 902. Accordingly, in some cases, it is desirable to capture a sequence of images in which the blur level images between pairs of images used for artifact correction does not exceed the threshold blur level. In addition, as noted above, it may be desirable for the image with the highest blur level (e.g., defocused image 908) to be captured at the extreme end range of an AF lens of a camera system to maximize the likelihood that the image with the highest blur level will not contain the moiré artifacts.

In some cases, the additional defocused images with blur levels between the maximum blur level and the focused image can be selected such that the increment of blur level between pairs of images used for artifact correction remains equal.

In some cases, increasing the number of defocused images and recursive correction steps may not provide additional advantage while incurring additional computational effort, battery consumption, memory usage, or the like. Accordingly, the number of defocused images captured for performing artifact correction should be selected to provide an appropriate balance between image quality and computational effort. In some implementations, correction of a focused image 902 using between two and three defocused images can provide such a balance.

However, it should be noted that in some cases, the position of the AF lens during capture of a focused image may not allow for the capture of more than one defocused image within the range of the AF lens and/or capturing additional defocused images within the range of the AF lens may not provide additional benefit over the use of a single defocused image for artifact correction. In such a scenario, correction of the focused image using only one defocused image (e.g., as shown in FIG. 9B) may be suitable for providing artifact correction.

Returning to FIG. 5, the correction engine 516 can output the corrected version of the focused image (e.g., corrected focused image 940 of FIG. 9A, corrected focused image 1040 of FIG. 10C) to produce the output image 530.

In some implementations, the artifact detection and correction engine 510 can include and/or be included in the image processing device 105B of FIG. 1. In some examples, the artifact detection and correction engine 510 can include and/or be included in the image processor 150 of FIG. 1. In some cases, the artifact detection and correction engine 510 can include and/or be included in image capture and processing system 100 of FIG. 1, the compute components 210 of FIG. 2, the image processing engine 224 of FIG. 2, the computing system 1200 of FIG. 12, and/or any combination thereof.

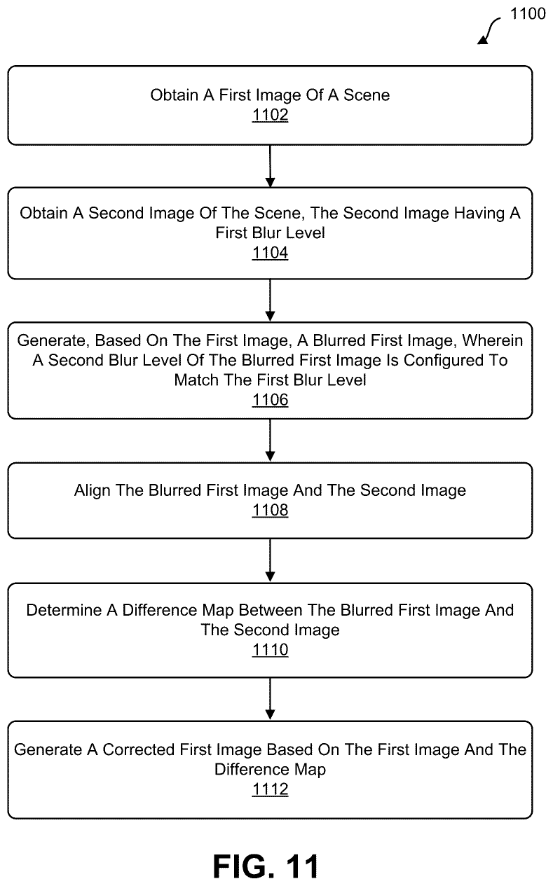

FIG. 11 is a flow diagram of a process 1100 for processing images. The process 1100 may be performed by a computing device (or apparatus) or a component (e.g., a chipset, codec, etc.) of the computing device. The computing device may be a mobile device, a network-connected wearable such as a watch, an XR device such as a VR device or AR device, a vehicle or component or system of a vehicle, a network node/entity/device, wireless device, or other type of computing device. The operations of the process 1100 may be implemented as software components that are executed and run on one or more processors.

At block 1102, the computing device (or component thereof) may obtain a first image of a scene (e.g., image 802 of FIG. 8). In some cases, the first image comprises a focused image of the scene. For example, the focused image of the scene may include one or more moiré artifacts.

At block 1104, the computing device (or component thereof) may obtain a second image of the scene, the second image having a first blur level (e.g., defocused image 904 of FIG. 9A). In some cases, the first image of the scene is captured by a camera with a first focus setting and the second image of the scene is captured by the camera with a second focus setting, the second focus setting being different from the first focus setting. In some implementations, the second focus setting may include a maximum defocus of a lens of the camera. In some examples, the first image can correspond to defocused image 904 of FIG. 9A and the second image can correspond to defocused image 906 of FIG. 9A. In some aspects, the second image is devoid of moiré artifacts. In some examples, the computing device (or component thereof) may determine that the second image is devoid of moiré artifacts.

At block 1106, the computing device (or component thereof) may generate, based on the first image, a blurred first image (e.g., by blur engine 909 of FIG. 9A). In some cases, a second blur level of the blurred first image is configured to match the first blur level.

At block 1108, the computing device (or component thereof) may align the blurred first image and the second image (e.g., using alignment engine 913 of FIG. 9A).

At block 1110, the computing device (or component thereof) may determine a difference map (e.g., by difference engine 926 of FIG. 9A) between the blurred first image and the second image. In some aspects, the difference map comprises a residual moiré artifact present in the blurred first image and absent in the second image.

At block 1112, the computing device (or component thereof) may generate a corrected first image (e.g., corrected focused image 940 of FIG. 9A) based on the first image and the difference map. In some examples, the computing device (or component thereof) may generate the corrected first image by subtracting the difference map from the first image. In some cases, the corrected first image has a third blur level, the third blur level being less than the first blur level and the second blur level.

In some implementations, the computing device (or component thereof) may obtain a third image of the scene, the third image having a fourth blur level that is less than the third blur level. The computing device (or component thereof) may generate, based on the third image, a blurred third image. In some aspects, a fifth blur level of the blurred third image is configured to match the third blur level. In some examples, the computing device (or component thereof) may align the blurred third image and the corrected first image. In some cases, the computing device (or component thereof) may determine an additional difference map between the blurred third image and the corrected first image and generate a corrected third image based on the third image and the additional difference map. In some aspects, to generate the corrected third image, the computing device (or component thereof) may subtract the additional difference map from the third image. In some examples, the third image comprises a focused image of the scene.

The process 1100 illustrated in FIG. 11 may also include any operation discussed illustrated in, or discussed with respect to, the image capture and processing system 100 of FIG. 1, the image capture device 105A of FIG. 1, the image processing device 105B of FIG. 1, the XR system 200 of FIG. 2, the artifact detection and correction engine 510 of FIG. 5, the correction engine 516 of FIG. 5, the blur level matching and motion estimation engine 800 of FIG. 8, the recursive image correction engine 900 of FIG. 9A, or a combination thereof. The image processing of FIG. 11 may represent at least some of the operations of an image capture and processing system 100, an image capture device 105A, an image processing device 105B, an XR system 200, a computing system 1200, or a combination thereof.

In some cases, at least a subset of the techniques illustrated by the process 1100 may be performed remotely by one or more network servers of a cloud service. In some examples, the processes described herein (e.g., process 1100 and/or other process(es) described herein) may be performed by a computing device or apparatus. In some examples, the process 1100 can be performed by the image capture device 105A of FIG. 1. In some examples, the process 1100 can be performed by the image processing device 105B of FIG. 1. The process 1100 can also be performed by the image capture and processing system 100 of FIG. 1. The process 1100 can also be performed by the XR device of FIG. 2, the correction engine 510 of FIG. 5, the blur level matching and motion estimation engine 800 of FIG. 8, the recursive image correction engine 900 of FIG. 9A, and/or any combination or variation thereof.

The process 1100 can also be performed by a computing device with the architecture of the computing system 1200 shown in FIG. 12. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1100. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes illustrated by block diagrams in FIG. 1 (of image capture and processing system 100), FIG. 2 (of XR system 200), FIG. 5 (of diagram 500), FIG. 8 (of blur level matching and motion estimation engine 800), FIG. 9A (of recursive image correction engine 900), and FIG. 12 (of computing system 1200) and the flow diagram illustrating process 1100 are illustrative of, or organized as, logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes illustrated by block diagrams 100, 200, and 1200 and the flow diagram illustrating process 1100 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which can be for example any computing device making up the image capture and processing system 100, the image capture device 105A, the image processing device 105B, the XR system, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example computing system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1002.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1: A method of processing images, the method comprising: obtaining a first image of a scene; obtaining a second image of the scene, the second image having a first blur level; generating, based on the first image, a blurred first image, wherein a second blur level of the blurred first image is configured to match the first blur level; aligning the blurred first image and the second image; determining a difference map between the blurred first image and the second image; and generating a corrected first image based on the first image and the difference map.
Aspect 2: The method of Aspect 1, wherein generating the corrected first image comprises subtracting the difference map from the first image.
Aspect 3: The method of any one of Aspects 1 to 2, wherein the first image comprises a focused image of the scene.
Aspect 4: The method of Aspect 3, wherein the focused image of the scene includes one or more moiré artifacts.
Aspect 5: The method of Aspect 4, wherein the second image is devoid of moiré artifacts.
Aspect 6: The method of any one of Aspects 1 to 5, further comprising determining that the second image is devoid of moiré artifacts.
Aspect 7: The method of any one of Aspects 1 to 6, wherein the corrected first image has a third blur level, the third blur level being less than the first blur level and the second blur level.
Aspect 8: The method of Aspect 7, further comprising: obtaining a third image of the scene, the third image having a fourth blur level, the fourth blur level being less than the third blur level; generating, based on the third image, a blurred third image, wherein a fifth blur level of the blurred third image is configured to match the third blur level; aligning the blurred third image and the corrected first image; determining an additional difference map between the blurred third image and the corrected first image; and generating a corrected third image based on the third image and the additional difference map.
Aspect 9: The method of Aspect 8, wherein generating the corrected third image comprises subtracting the additional difference map from the third image.
Aspect 10: The method of any one of Aspects 8 or 9, wherein the third image comprises a focused image of the scene.
Aspect 11: The method of any one of Aspects 1 to 10, wherein the first image of the scene is captured by a camera with a first focus setting and the second image of the scene is captured by the camera with a second focus setting, the second focus setting being different from the first focus setting.
Aspect 12: The method of Aspect 11, wherein the second focus setting comprises a maximum defocus of a lens of the camera.
Aspect 13: The method of any one of Aspects 1 to 12, wherein the difference map comprises a residual moiré artifact present in the blurred first image and absent in the second image.
Aspect 14: An apparatus for processing one or more frames, comprising: a memory; and a processor coupled to the memory, the processor configured to: obtain a first image of a scene; obtain a second image of the scene, the second image having a first blur level; generate, based on the first image, a blurred first image, wherein a second blur level of the blurred first image is configured to match the first blur level; align the blurred first image and the second image; determine a difference map between the blurred first image and the second image; and generate a corrected first image based on the first image and the difference map.
Aspect 15: The apparatus of Aspect 14, wherein generating the corrected first image comprises subtracting the difference map from the first image.
Aspect 16: The apparatus of any one of Aspects 14 to 15, wherein the first image comprises a focused image of the scene.
Aspect 17: The apparatus of Aspect 16, wherein the focused image of the scene includes one or more moiré artifacts.
Aspect 18: The apparatus of Aspect 17, wherein the second image is devoid of moiré artifacts.
Aspect 19: The apparatus of any one of Aspects 14 to 18, wherein the processor is configured to determine that the second image is devoid of moiré artifacts.
Aspect 20: The apparatus of any one of Aspects 14 to 19, wherein the corrected first image has a third blur level, the third blur level being less than the first blur level and the second blur level.
Aspect 21: The apparatus of Aspect 20, wherein the processor is configured to: obtain a third image of the scene, the third image having a fourth blur level, the fourth blur level being less than the third blur level; generate, based on the third image, a blurred third image, wherein a fifth blur level of the blurred third image is configured to match the third blur level; align the blurred third image and the corrected first image; determine an additional difference map between the blurred third image and the corrected first image; and generate a corrected third image based on the third image and the additional difference map.
Aspect 22: The apparatus of Aspect 21, wherein, to generate the corrected third image, the processor is configured to subtract the additional difference map from the third image.
Aspect 23: The apparatus of any one of Aspects 21 or 22, wherein the third image comprises a focused image of the scene.
Aspect 24: The apparatus of any one of Aspects 14 to 23, wherein the first image of the scene is captured by a camera with a first focus setting and the second image of the scene is captured by the camera with a second focus setting, the second focus setting being different from the first focus setting.
Aspect 25: The apparatus of Aspect 24, wherein the second focus setting comprises a maximum defocus of a lens of the camera.
Aspect 26: The apparatus of any one of Aspects 14 to 25, wherein the difference map comprises a residual moiré artifact present in the blurred first image and absent in the second image.
Aspect 27: A non-transitory computer-readable storage medium having stored thereon instructions which, when executed by one or more processors, cause the one or more processors to perform any of the operations of aspects 1 to 26.
Aspect 28: An apparatus comprising means for performing any of the operations of aspects 1 to 26.

What is claimed is:

1. An apparatus for processing one or more frames, comprising:
a memory; and
a processor coupled to the memory and configured to:
obtain a first image of a scene;
obtain a second image of the scene, the second image having a first blur level;
generate, based on the first image, a blurred first image, wherein a second blur level of the blurred first image is configured to match the first blur level;
align the blurred first image and the second image;
determine a difference map between the blurred first image and the second image; and
generate a corrected first image based on the first image and the difference map.

2. The apparatus of claim 1, wherein, to generate the corrected first image, the processor is configured to subtract the difference map from the first image.

3. The apparatus of claim 1, wherein the first image comprises a focused image of the scene.

4. The apparatus of claim 3, wherein the focused image of the scene includes one or more moiré artifacts.

5. The apparatus of claim 4, wherein the second image is devoid of moiré artifacts.

6. The apparatus of claim 1, wherein the processor is configured determine that the second image is devoid of moiré artifacts.

7. The apparatus of claim 1, wherein the corrected first image has a third blur level, the third blur level being less than the first blur level and the second blur level.

8. The apparatus of claim 7, wherein the processor is configured to:
obtain a third image of the scene, the third image having a fourth blur level, the fourth blur level being less than the third blur level;
generate, based on the third image, a blurred third image, wherein a fifth blur level of the blurred third image is configured to match the third blur level;
align the blurred third image and the corrected first image;
determine an additional difference map between the blurred third image and the corrected first image; and
generate a corrected third image based on the third image and the additional difference map.

9. The apparatus of claim 8, wherein, to generate the corrected third image, the processor is configured subtract the additional difference map from the third image.

10. The apparatus of claim 8, wherein the third image comprises a focused image of the scene.

11. The apparatus of claim 1, wherein the first image of the scene is captured by a camera with a first focus setting and the second image of the scene is captured by the camera with a second focus setting, the second focus setting being different from the first focus setting.

12. The apparatus of claim 11, wherein the second focus setting comprises a maximum defocus of a lens of the camera.

13. The apparatus of claim 1, wherein the difference map comprises a residual moiré artifact present in the blurred first image and absent in the second image.

14. A method of processing images, the method comprising:
obtaining a first image of a scene;
obtaining a second image of the scene, the second image having a first blur level;
generating, based on the first image, a blurred first image, wherein a second blur level of the blurred first image is configured to match the first blur level;
aligning the blurred first image and the second image;
determining a difference map between the blurred first image and the second image; and
generating a corrected first image based on the first image and the difference map.

15. The method of claim 14, wherein generating the corrected first image comprises subtracting the difference map from the first image.

16. The method of claim 14, wherein the first image comprises a focused image of the scene.

17. The method of claim 16, wherein the focused image of the scene includes one or more moiré artifacts.

18. The method of claim 17, wherein the second image is devoid of moiré artifacts.

19. The method of claim 14, further comprising determining that the second image is devoid of moiré artifacts.

20. The method of claim 14, wherein the corrected first image has a third blur level, the third blur level being less than the first blur level and the second blur level.
